(19) United States
(12) Patent Application Publication
(10) Pub. No.: US 2008/0072860 A1
(43) Pub. Date: Mar. 27, 2008

(54) Driving Apparatus, Control Method Of Driving Apparatus, And Motor Vehicle Equipped With Driving Apparatus

(75) Inventors: Makoto Nakamura, Aichi-ken (JP); Mitsuhiro Tabata, Shizuoka-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/792,341

(22) PCT Filed: Dec. 9, 2005
(86) PCT No.: PCT/JP05/23100

§ 371 Date: Jun. 5, 2007

(30) Foreign Application Priority Data
Dec. 10, 2004 (JP) 2004-357744

(51) Int. Cl. F02N 17/00

(52) U.S. Cl. 123/179.4; 123/406.47

(57) ABSTRACT

Upon the setting of a gearshift position SP to a drivable gear position, for example, a drive position for general forward drive or a braking position for applying brake on downslope, when an engine rotation speed Ne decreases to or below a preset fuel injection-start reference rotation speed Nref1, a driving apparatus of the invention allows preliminary fuel injection before a stop of an engine into a specific cylinder that stops in a preset fuel injection stop range over an intake stroke to a compression stroke on the stop of the engine (steps S140 and S150). Upon the setting of the gearshift position SP to a non-drivable gear position, for example, a parking position for parking lock or a neutral position for keeping the gear neutral, on the other hand, the driving apparatus of the invention prohibits the preliminary fuel injection into the specific cylinder that stops in the fuel injection stop range on the stop of the engine (steps S140 and S190). This arrangement ensures a quick restart of the engine and effectively avoids potential troubles caused by non-combustion of the preliminarily injected fuel under a stop of the engine over a relatively long time.

### TECHNICAL FIELD

The present invention relates to a driving apparatus, a control method of the driving apparatus, and a motor vehicle equipped with the driving apparatus. More specifically the invention pertains to a driving apparatus including an internal combustion engine that is capable of outputting power to a drive shaft, a control method of such a driving apparatus, and a motor vehicle equipped with such a driving apparatus.

### BACKGROUND ART

A proposed driving apparatus enables ignition and combustion of the air-fuel mixture in a cylinder having a first ignition timing on an automatic restart of an internal combustion engine after its automatic stop (see, for example, Japanese Patent Laid-Open Gazette No. 2001-342876). The ignition and combustion of the air-fuel mixture in the cylinder having the first ignition timing achieves a quick restart of the internal combustion engine.

### DISCLOSURE OF THE INVENTION

In an internal combustion engine where a fuel is individually injected into the respective intake systems of multiple cylinders, the fuel injection is generally performed in a final phase of an exhaust stroke. The ignition and combustion of the air-fuel mixture in a selected cylinder having a first ignition timing accordingly requires fuel injection into the selected cylinder in the final phase of the exhaust stroke immediately before a stop of the internal combustion engine. The selected cylinder having the first ignition timing stops in a certain range over an intake stroke to a compression stroke on the stop of the internal combustion engine. Non-combustion of the fuel preliminarily injected into a cylinder may cause significant troubles when the internal combustion engine is kept at a stop for a relatively long time. The troubles include, for example, direct discharge of uncombusted fuel from a cylinder receiving the fuel injection and deterioration of lubricating oil in the internal combustion engine by the uncombusted fuel. Such troubles are negligible in the case of a restart of the internal combustion engine in a relatively short time but are unignorable in the case of a restart of the internal combustion engine after a relatively long time.

The driving apparatus of the invention, the control method of the driving apparatus, and the motor vehicle equipped with the driving apparatus thus aim to avoid potential troubles due to non-combustion of preliminarily injected fuel under a stop of an internal combustion engine. The driving apparatus of the invention, the control method of the driving apparatus, and the motor vehicle equipped with the driving apparatus also aim to enable a quick restart of the internal combustion engine.

In order to attain at least part of the above and the other related objects, the driving apparatus, the control method of the driving apparatus, and the motor vehicle equipped with the driving apparatus have the configurations discussed below.

The present invention is directed to a driving apparatus having an internal combustion engine that has multiple cylinders and is capable of outputting power to a drive shaft and includes: an engine stop-restart control module that, in response to reception of a stop instruction of the internal combustion engine, controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine, while in response to reception of a start instruction of the internal combustion engine, controlling the internal combustion engine to start with ignition of an air-fuel mixture at a first ignition timing in the specific cylinder that stops in the predetermined range; a state detection unit that detects a state of the driving apparatus; and an avoidance control module that executes potential trouble avoidance control based on the detected state of the driving apparatus, so as to avoid a potential trouble arising in the internal combustion engine due to non-combustion of preliminarily injected fuel.

In response to reception of a stop instruction of the internal combustion engine, the driving apparatus of the invention controls the internal combustion engine to allow preliminary fuel injection before a stop of the internal combustion engine into the specific cylinder, which stops in the predetermined range including part of the compression stroke on the stop of the internal combustion engine, among the multiple cylinders of the internal combustion engine. In response to reception of a start instruction of the internal combustion engine, the driving apparatus of the invention controls the internal combustion engine to start with ignition of the air-fuel mixture at a first ignition timing in the specific cylinder that stops in the predetermined range. The driving apparatus executes the potential trouble avoidance control based on the detected state of the driving apparatus, so as to avoid a potential trouble arising in the internal combustion engine due to non-combustion of the preliminarily injected fuel. The arrangement of the invention ensures a quick restart of the internal combustion engine and effectively avoids the potential trouble arising in the internal combustion engine due to non-combustion of the preliminary injected fuel. The ‘potential trouble arising in the internal combustion engine due to non-combustion of the preliminary injected fuel’ includes direct discharge of uncombusted fuel from a cylinder receiving the fuel injection and deterioration of lubricating oil in the internal combustion engine by the uncombusted fuel.

In one preferable embodiment of the invention, the driving apparatus further includes a state changeover structure that, in response to an operator's manipulation, changes over the state of the driving apparatus between a drivable state that enables output of the power of the internal combustion engine to the drive shaft and an undrivable state that prohibits output of the power of the internal combustion engine to the drive shaft. The state detection unit detects the state of the driving apparatus changed over by the state changeover structure. When the state detection unit detects a changeover of the state of the driving apparatus to the undrivable state by the state changeover structure, the avoidance control module executes the potential trouble avoidance control, which controls the engine stop-restart control module to prohibit the preliminary fuel injection before the stop of the internal combustion engine. When the driving apparatus is in the undrivable state, it is expected that the internal combustion engine is kept at a stop for a relatively long time. In this state, the driving apparatus prohibits the preliminary fuel injection, which is to be performed before the stop of the internal combustion engine in preparation for a restart of the internal combustion engine. This arrangement effectively avoids potential troubles caused by non-combustion of the preliminarily injected fuel under a stop of the internal combustion engine over a relatively long time. In this embodiment, the driving apparatus of the invention may also have an activation-inactivation instruction unit that gives an activation command and an inactivation command to activate and inactivate the driving apparatus, in response to the operator's manipulation. The state detection unit detects the inactivation command of the driving apparatus given by the activation-inactivation instruction unit. In response to detection of the inactivation command of the driving apparatus by the state detection unit after the preliminary fuel injection by the engine stop-restart control module, the avoidance control module executes the potential trouble avoidance control, which controls the internal combustion engine to ignite the air-fuel mixture in the specific cylinder receiving the preliminary fuel injection before the stop of the internal combustion engine. Such ignition enables combustion of the preliminary injected fuel in the specific cylinder and thus effectively avoids potential troubles caused by non-combustion of the preliminarily injected fuel under a stop of the internal combustion engine over a relatively long time.

In another preferable embodiment of the invention, the driving apparatus further includes an activation-inactivation instruction unit that gives an activation command and an inactivation command to activate and inactivate the driving apparatus, in response to the operator's manipulation. The state detection unit detects the inactivation command of the the driving apparatus given by the activation-inactivation instruction unit. In response to detection of the inactivation command of the driving apparatus by the state detection unit, the avoidance control module executes the potential trouble avoidance control, which controls the internal combustion engine to ignite the air-fuel mixture in the specific cylinder receiving the preliminary fuel injection before the stop of the internal combustion engine. When the driving apparatus is inactivated in response to the inactivation command, it is expected that the internal combustion engine is kept at a stop for a relatively long time. In this state, the driving apparatus ignites the air-fuel mixture in the specific cylinder receiving the preliminary fuel injection, which is performed before the stop of the internal combustion engine in preparation for a restart of the internal combustion engine. Such ignition enables combustion of the preliminary injected fuel in the specific cylinder and thus effectively avoids potential troubles caused by non-combustion of the preliminarily injected fuel under a stop of the internal combustion engine over a relatively long time.

In one preferable embodiment of the driving apparatus of the invention having the control to ignite the air-fuel mixture in the specific cylinder receiving the preliminary fuel injection in response to an inactivation command of the driving apparatus, upon condition that the specific cylinder receiving the preliminary fuel injection by the engine stop-restart control module before the stop of the internal combustion engine is at a stop in a preset range in the compression stroke, the avoidance control module executes the potential trouble avoidance control, which controls the internal combustion engine to ignite the air-fuel mixture in the specific cylinder, in response to detection of the inactivation command of the driving apparatus by the state detection unit. In the driving apparatus of this embodiment, upon condition that the specific cylinder receiving the preliminary fuel injection by the engine stop-restart control module before the stop of the internal combustion engine is not at a stop in the preset range in the compression stroke, the avoidance control module executes the potential trouble avoidance control, which controls the internal combustion engine to be cranked with the ignition of the air-fuel mixture in the specific cylinder. In another preferable embodiment of the driving apparatus of the invention having the control to ignite the air-fuel mixture in the specific cylinder receiving the preliminary fuel injection in response to an inactivation command of the driving apparatus, the avoidance control module executes the potential trouble avoidance control, which controls the internal combustion engine to be cranked with the ignition of the air-fuel mixture in the specific cylinder receiving the preliminary fuel injection, after the stop of the internal combustion engine by the engine stop-restart control module.

In the driving apparatus of the invention, the avoidance control module may execute the potential trouble avoidance control, which controls the internal combustion engine to decrease an amount of intake air flow into the internal combustion engine at a time of the preliminary fuel injection into the specific cylinder that stops in the predetermined range on the stop of the internal combustion engine. This arrangement restricts the amount of the uncombusted fuel and thereby desirably reduces potential troubles caused by non-combustion of the preliminarily injected fuel under a stop of the internal combustion engine over a relatively long time.

The present invention is directed to a motor vehicle including: an internal combustion engine that has multiple cylinders and is capable of outputting power to an axle of the motor vehicle; an engine stop-restart control module that, in response to reception of a stop instruction of the internal combustion engine, controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine, while in response to reception of a start instruction of the internal combustion engine, controlling the internal combustion engine to start with ignition of an air-fuel mixture at a first ignition timing in the specific cylinder that stops in the predetermined range; a state detection unit that detects a state of the motor vehicle; and an avoidance control module that executes potential trouble avoidance control based on the detected state of the motor vehicle, so as to avoid a potential trouble arising in the internal combustion engine due to non-combustion of preliminarily injected fuel.

In response to reception of a stop instruction of the internal combustion engine, the motor vehicle of the invention controls the internal combustion engine to allow preliminary fuel injection before a stop of the internal combustion engine into the specific cylinder, which stops in the predetermined range including part of the compression stroke on the stop of the internal combustion engine, among the multiple cylinders of the internal combustion engine. In response to reception of a start instruction of the internal combustion engine, the motor vehicle of the invention controls the internal combustion engine to start with ignition of the air-fuel mixture at a first ignition timing in the specific cylinder that stops in the predetermined range. The motor vehicle executes the potential trouble avoidance control based on the detected state of the driving apparatus, so as to avoid a potential trouble arising in the internal combustion engine due to non-combustion of the preliminarily injected fuel. The arrangement of the invention ensures a quick restart of the internal combustion engine and effectively avoids the potential trouble arising in the internal combustion engine due to non-combustion of the preliminary injected fuel. The ‘potential trouble arising in the internal combustion engine due to non-combustion of the preliminary injected fuel’ includes direct discharge of uncombusted fuel from a cylinder receiving the fuel injection and deterioration of lubricating oil in the internal combustion engine by the uncombusted fuel.

In one preferable embodiment of the invention, the motor vehicle further includes: a state changeover structure that, in response to an operator's manipulation, changes over the state of the motor vehicle between a drivable state that enables output of the power of the internal combustion engine to the axle and an undrivable state that prohibits output of the power of the internal combustion engine to the axle. The state detection unit may detect the state of the motor vehicle changed over by the state changeover structure, and when the state detection unit detects a changeover of the state of the motor vehicle to the undrivable state by the state changeover structure, the avoidance control module may execute the potential trouble avoidance control, which controls the engine stop-restart control module to prohibit the preliminary fuel injection before the stop of the internal combustion engine. In this state, the driving apparatus prohibits the preliminary fuel injection, which is to be performed before the stop of the internal combustion engine in preparation for a restart of the internal combustion engine. This arrangement effectively avoids potential troubles caused by non-combustion of the preliminarily injected fuel under a stop of the internal combustion engine over a relatively long time.

In another preferable embodiment of the invention, the motor vehicle further includes: a start-stop instruction unit that gives a start command and a stop command to start and stop the motor vehicle, in response to an operator's manipulation. The state detection unit may detect the stop command of the motor vehicle given by the start-stop instruction unit, and in response to detection of the stop command of the motor vehicle by the state detection unit, the avoidance control module may execute the potential trouble avoidance control, which controls the internal combustion engine to ignite the air-fuel mixture in the specific cylinder receiving the preliminary fuel injection before the stop of the internal combustion engine. In this state, the driving apparatus ignites the air-fuel mixture in the specific cylinder receiving the preliminary fuel injection, which is performed before the stop of the internal combustion engine in preparation for a restart of the internal combustion engine. Such ignition enables combustion of the preliminary injected fuel in the specific cylinder and thus effectively avoids potential troubles caused by non-combustion of the preliminarily injected fuel under a stop of the internal combustion engine over a relatively long time.

In the motor vehicle of the invention, the avoidance control module may execute the potential trouble avoidance control, which controls the internal combustion engine to decrease an amount of intake air flow into the internal combustion engine at a time of the preliminary fuel injection into the specific cylinder that stops in the predetermined range on the stop of the internal combustion engine. This arrangement restricts the amount of the uncombusted fuel and thereby desirably reduces potential troubles caused by non-combustion of the preliminarily injected fuel under a stop of the internal combustion engine over a relatively long time.

The present invention is directed to a first control method of a driving apparatus including: an internal combustion engine that has multiple cylinders and is capable of outputting power to a drive shaft; and a state changeover structure that, in response to an operator's manipulation, changes over a state of the driving apparatus between a drivable state that enables output of the power of the internal combustion engine to the drive shaft and an undrivable state that prohibits output of the power of the internal combustion engine to the drive shaft. In response to reception of a stop instruction of the internal combustion engine, the first driving apparatus control method controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine. In the event of a changeover of the state of the driving apparatus to the undrivable state by the state changeover structure, the first driving apparatus control method controls the internal combustion engine to prohibit the preliminary fuel injection before the stop of the internal combustion engine. In response to reception of a start instruction of the internal combustion engine, the first driving apparatus control method controls the internal combustion engine to start with ignition of an air-fuel mixture at a first ignition timing in the specific cylinder that stops in the predetermined range.

In response to reception of a stop instruction of the internal combustion engine, the first driving apparatus control method controls the internal combustion engine to allow preliminary fuel injection before a stop of the internal combustion engine into the specific cylinder, which stops in the predetermined range including part of the compression stroke on the stop of the internal combustion engine, among the multiple cylinders of the internal combustion engine. In the event of a changeover of the state of the driving apparatus to the undrivable state that prohibits the output of the power of the internal combustion engine to the drive shaft, the first driving apparatus control method controls the internal combustion engine to prohibit the preliminary fuel injection before the stop of the internal combustion engine. In response to reception of a start instruction of the internal combustion engine, the first driving apparatus control method controls the internal combustion engine to start with ignition of an air-fuel mixture at a first ignition timing in the specific cylinder that stops in the predetermined range. This arrangement of the invention ensures a quick restart of the internal combustion engine and effectively avoids the potential trouble arising in the internal combustion engine due to non-combustion of the preliminary injected fuel. The ‘potential trouble arising in the internal combustion engine due to non-combustion of the preliminary injected fuel’ includes direct discharge of uncombusted fuel from a cylinder receiving the fuel injection and deterioration of lubricating oil in the internal combustion engine by the uncombusted fuel.

The present invention is also directed to a second control method of a driving apparatus including: an internal combustion engine that has multiple cylinders and is capable of outputting power to a drive shaft; and an activation-inactivation instruction unit that gives an activation command and an inactivation command to activate and inactivate the driving apparatus, in response to an operator's manipulation. In response to reception of a stop instruction of the internal combustion engine, the second driving apparatus control method controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine. In response to the inactivation command of the driving apparatus given by the activation-inactivation instruction unit, the second driving apparatus control method controls the internal combustion engine to ignite an air-fuel mixture in the specific cylinder receiving the preliminary fuel injection before the stop of the internal combustion engine. In response to reception of a start instruction of the internal combustion engine, the second driving apparatus control method controlling the internal combustion engine to start with ignition of the air-fuel mixture at a first ignition timing in the specific cylinder that stops in the predetermined range.

In response to reception of a stop instruction of the internal combustion engine, the second driving apparatus control method controls the internal combustion engine to allow preliminary fuel injection before a stop of the internal combustion engine into the specific cylinder, which stops in the predetermined range including part of the compression stroke on the stop of the internal combustion engine, among the multiple cylinders of the internal combustion engine. In response to the inactivation command of the driving apparatus, the second driving apparatus control method controls the internal combustion engine to ignite the air-fuel mixture in the specific cylinder receiving the preliminary fuel injection before the stop of the internal combustion engine. In response to reception of a start instruction of the internal combustion engine, the second driving apparatus control method controls the internal combustion engine to start with ignition of the air-fuel mixture at a first ignition timing in the specific cylinder that stops in the predetermined range. This arrangement of the invention ensures a quick restart of the internal combustion engine and effectively avoids the potential trouble arising in the internal combustion engine due to non-combustion of the preliminary injected fuel. The ‘potential trouble arising in the internal combustion engine due to non-combustion of the preliminary injected fuel’ includes direct discharge of uncombusted fuel from a cylinder receiving the fuel injection and deterioration of lubricating oil in the internal combustion engine by the uncombusted fuel.

### BRIEF DESCRIPTION OF THE DRAWINGS

FIG. 1 schematically illustrates the configuration of a motor vehicle equipped with a driving apparatus in one embodiment of the invention;

FIG. 2 shows fuel injection and ignition with a change of a crank angle CA in four strokes in four cylinders of an engine included in the driving apparatus of the embodiment;

FIG. 3 is a flowchart showing an engine stop control routine executed by an engine ECU included in the driving apparatus of the embodiment;

FIG. 4 is a flowchart showing a system stop control routine executed by the engine ECU;

FIG. 5 shows one example of a fuel injection stop range;

FIG. 6 shows one example of an ignition range;

FIG. 7 shows fuel injection and ignition with another change of the crank angle CA in the four strokes in the four cylinders of the engine;

FIG. 8 shows fuel injection and ignition with still another change of the crank angle CA in the four strokes in the four cylinders of the engine; and

FIG. 9 is a flowchart showing an engine start control routine executed by the engine ECU.

### BEST MODES OF CARRYING OUT THE INVENTION

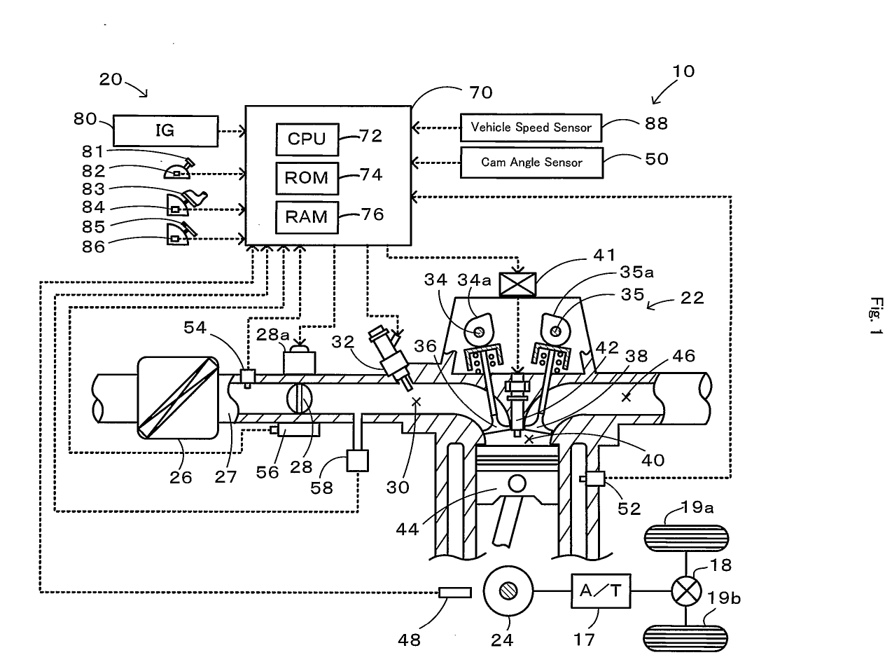

One mode of carrying out the invention is described below as a preferred embodiment. FIG. 1 schematically illustrates the configuration of a motor vehicle 10 equipped with a driving apparatus 20 in one embodiment of the invention. As illustrated, the motor vehicle 10 includes an engine 22 driven with gasoline, an engine electronic control unit (hereafter referred to as engine ECU) 70 that controls the engine 22, an automatic transmission (A/T) 17 that converts power of a crankshaft 24 of the engine 22 and outputs the converted power to drive wheels 19a and 19b via a differential gear 18, and an A/T electronic control unit (not shown) that controls the automatic transmission 17. The engine 22, the engine ECU 70, and sensors connected to inputs of the engine ECU 70 constitute the driving apparatus 20 of the embodiment.

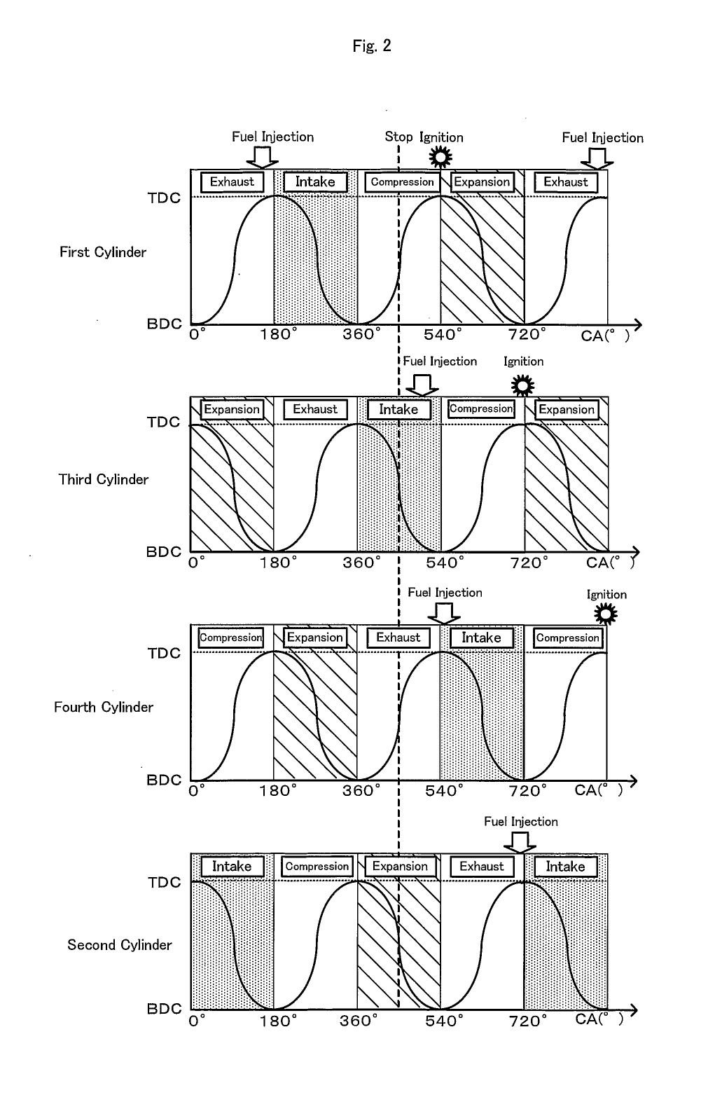

The engine 22 is an individual-injection-type 4-cylinder engine that is capable of individually injecting a fuel in respective cylinders 22a to 22d of an intake manifold 30. Each of the four cylinders 22a to 22d in the engine 22 is driven in a cycle including an intake stroke, a compression stroke, an expansion stroke (combustion stroke), and an exhaust stroke. The first cylinder 22a, the second cylinder 22b, the third cylinder 22c, and the fourth cylinder 22d are arranged in series in this sequence, while the first cylinder 22a, the third cylinder 22c, the fourth cylinder 22d, and the second cylinder 22b are linked to the crankshaft 24 to have different crank angles CA by 180 degrees in this sequence. FIG. 2 shows variations of the crank angle CA in four strokes of the respective cylinders 22a to 22d. FIG. 2 also shows a fuel injection timing in engine stop control and a fuel injection timing and an ignition timing in an engine start control, which will be discussed later.

The engine 22 has an air cleaner 26 that cleans the intake air, a throttle valve 28 that is attached to an intake pipe 27 and is driven by a throttle motor 28a to regulate the amount of intake air, fuel injection valves 32 that are attached to branches of the intake manifold 30 diverging corresponding to the four cylinders 22a to 22d to individually inject a fuel, that is, gasoline, in the respective cylinders 22a to 22d, and an intake valve 36 that is driven by a cam 34a of a cam shaft 34 rotating at a ratio of 1 rotation to 2 rotations of the crankshaft 24 to introduce the mixture of gasoline and the air (the air-fuel mixture) into respective combustion chambers 40. The engine 22 also includes an ignition plug 42 that applies a voltage to an ignition coil 41 integrated with an igniter at a timing from a compression stroke to an expansion stroke to generate an electric spark in the combustion chamber 40, an exhaust valve 38 that is driven by a cam 35a of a cam shaft 35 rotating at a ratio of 1 rotation to 2 rotations of the crankshaft 24 to discharge the combustion exhaust gas from the combustion chamber 40 into an exhaust manifold 46, and a catalytic converter (not shown) of a three-way catalyst that converts toxic compounds in the exhaust gas, that is, carbon monoxide (CO), hydrocarbons (HC), and nitrogen oxides (NOx). The reciprocating motions of a piston 44 pressed down by the energy of explosive combustion of the air-fuel mixture in the combustion chamber 40 are converted into the rotating motions of the crankshaft 24.

A crank angle sensor 48 is mounted on the crankshaft 24 of the engine 22 to measure a crank angle CA as a rotation angle of the crankshaft 24. A cam angle sensor 50 is mounted on each of the cam shafts 34 and 35 to measure a cam angle as a rotation angle of the cam shaft 34 or 35. The engine 22 is also equipped with various sensors to observe the conditions of the engine 22. Such sensors include a water temperature sensor 52 that measures the temperature of cooling water in the engine 22, an intake air temperature sensor 54 that measures the temperature of the intake air, a throttle valve position sensor 56 that detects the position of the throttle valve 28 or the throttle position, and a vacuum sensor 58 that measures the amount of intake air as the load of the engine 22. Output signals of these sensors are input into the engine ECU 70. The crank angle sensor 48 is an MRE rotation sensor having a magnetic resistance element arranged at a position to face a magnet rotor (not shown) attached to the crankshaft 24. The crank angle sensor 48 generates a pulse at every preset angle (for example, at every crank angle CA of 10 degrees). In the structure of this embodiment, the engine ECU 70 specifies the crank angle CA or the rotation angle of the crankshaft 24 in response to the pulses generated by the crank angle sensor 48 and computes rotation speed Ne of the engine 22.

The engine ECU 70 is constructed as a microcomputer including a CPU 72, a ROM 74 that stores processing programs, a RAM 76 that temporarily stores data, input and output ports (not shown), and a communication port (not shown). The engine ECU 70 receives, via its input port, signals from the various sensors, that is, the crank angle CA from the crank angle sensor 48, the cam angles from the cam angle sensors 50, the temperature of cooling water from the water temperature sensor 52, the temperature of the intake air from the intake air temperature sensor 54, the throttle position from the throttle valve position sensor 56, and the amount of the intake air from the vacuum sensor 58. The engine ECU 70 also receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, and a vehicle speed V from a vehicle speed sensor 88. The engine ECU 70 outputs, via its output port, driving signals to the fuel injection valves 32 and to the throttle motor 28a that adjusts the position of the throttle valve 28, as well as control signals to the ignition coil 41. The gearshift position SP of the gearshift lever 81 is selectable among available gear positions, a drive position (D position) for general forward drive, a reverse position (R position) for reverse drive, a braking position (B position) for applying brake on downslope, a parking position (P position) for parking lock, and a neutral position (N position) for keeping the gear neutral.

The description now regards the operations of the driving apparatus 20 mounted on the motor vehicle 10 of the embodiment having the configuration discussed above, especially a series of engine stop control at an idle stop of the engine 22. In the motor vehicle 10 of the embodiment, the engine 22 automatically stops under preset auto stop conditions, for example, the vehicle speed V equal to 0 and the driver's depression of the brake pedal 85. The engine 22 automatically starts under preset auto restart conditions, for example, the driver's release of the depressed brake pedal 85 after an auto stop of the engine 22. The auto stop control and the auto start control of the engine 22 are not characteristic of the invention and are thus not described in detail.

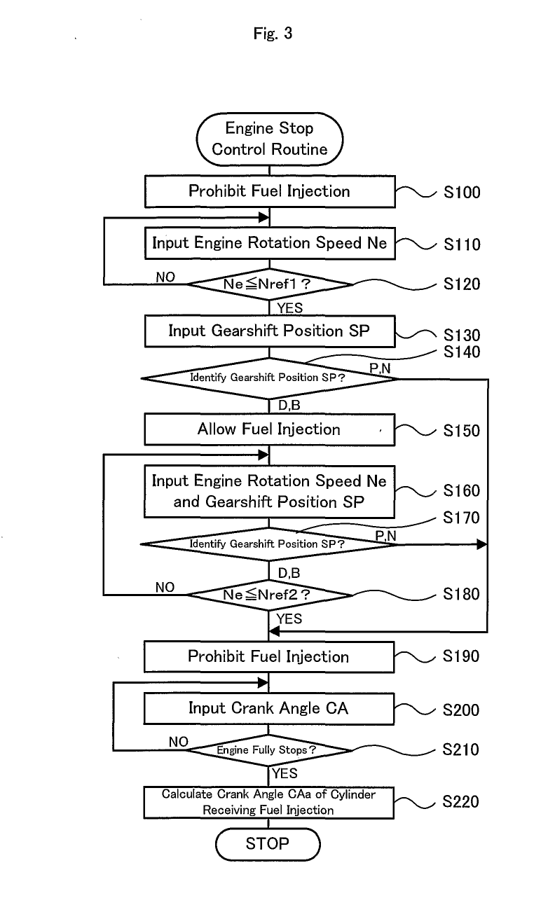

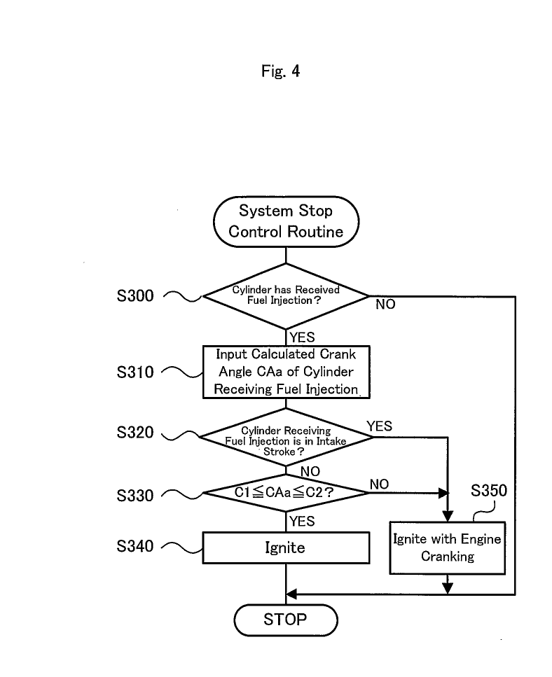

FIG. 3 is a flowchart showing an engine stop control routine executed by the engine ECU 70 upon satisfaction of preset automatic engine stop conditions. FIG. 4 is a flowchart showing a system stop control routine executed by the engine ECU 70 in response to a changeover of the gearshift position SP to the P position and a subsequent switch-off operation of the ignition switch 80 after a stop of the engine 22. The description regards a series of control process at a time of stopping the engine 22 and a series of control process at a time of stopping the system in this sequence with reference to the engine stop control routine of FIG. 3 and the system stop control routine of FIG. 4. At the time of stopping the engine 22 upon satisfaction of the preset automatic engine stop conditions, the throttle valve 28 is regulated to a specific opening that enables the engine 22 to be driven at an idle rotation speed.

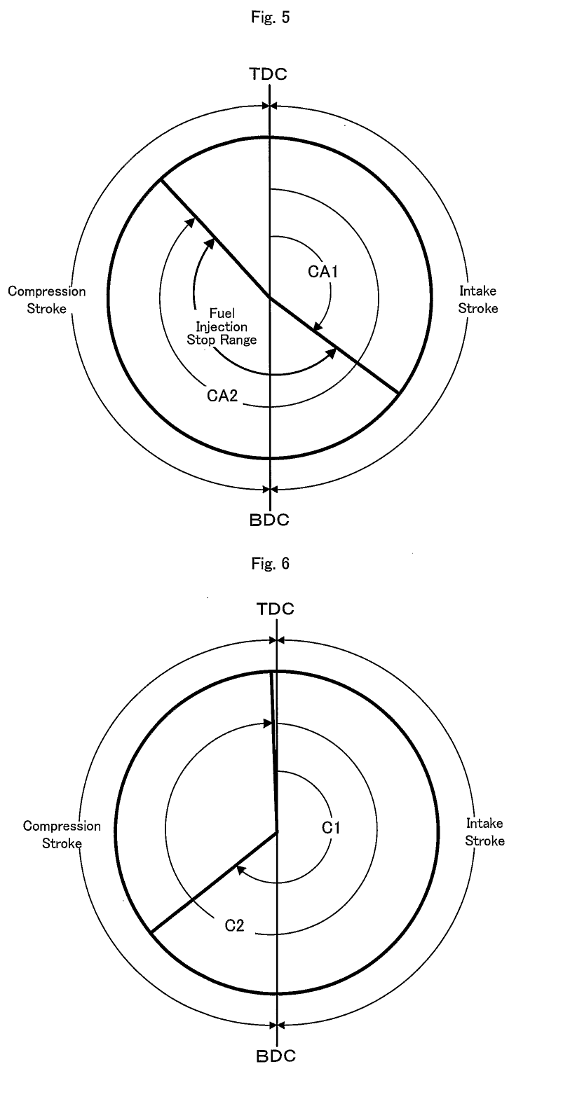

In the engine stop control routine of FIG. 3, the CPU 72 of the engine ECU 70 first prohibits fuel injection into the respective cylinders 22a to 22d (step S100). The prohibition of fuel injection cuts off the fuel supply and thereby lowers the rotation speed Ne of the engine 22. The CPU 72 waits until the input rotation speed Ne of the engine 22 decreases to or below a preset fuel injection-start reference rotation speed Nref1 (steps S110 and S120). In this embodiment, the rotation speed Ne of the engine 22 is input after computation from the pulses generated by the crank angle sensor 48 according to an engine rotation speed computation routine (not shown). The rotation speed Ne of the engine 22 may otherwise be computed from input data of the pulses generated by the crank angle sensor 48 in this engine stop control routine. The fuel injection-start reference rotation speed Nref1 is set as a maximum rotation speed that allows fuel injection into a selected cylinder immediately before a stop of the engine 22. The selected cylinder stops at its crank angle CA in a range between a preset first angle CA1 and a preset second angle CA2 (hereafter referred to as fuel injection stop range) over the intake stroke to the compression stroke in a stop of the engine 22. FIG. 5 shows one example of the fuel injection stop range. The fuel injection stop range is set to enable combustion of the air-fuel mixture at a first ignition timing (close to a top dead center TDC in the compression stroke) for a restart of the engine 22 after a stop of the engine 22 and to quickly raise the rotation speed Ne of the engine 22. In this embodiment, the fuel injection stop range is between the first angle CA1 in the latter half of the intake stroke and the second angle CA2 in the latter half of the compression stroke.

When the input rotation speed Ne of the engine 22 decreases to or below the preset fuel injection-start reference rotation speed Nref1 at step S120, the CPU 72 inputs the gearshift position SP from the gearshift position sensor 82 (step S130) and identifies the input gearshift position SP (step S140). When the identified gearshift position SP is a drivable gear position, for example, the D position or the B position, an immediate restart of the motor vehicle 10 is highly probable. The CPU 72 accordingly allows fuel injection (step S150). In response to permission of fuel injection, the engine ECU 70 activates the fuel injection valve 32 to inject the fuel into a cylinder having a fuel injection timing in the final phase of the exhaust stroke. The CPU 72 waits until the rotation speed Ne of the engine 22 further decreases to or below a preset fuel injection-stop reference rotation speed Nref2 without a changeover of the gearshift position SP to the P position or the N position (steps S160 to S180). When the rotation speed Ne is lowered to or below the fuel injection-stop reference rotation speed Nref2, the CPU 72 prohibits fuel injection (step S190). The fuel injection-stop reference rotation speed Nref2 is set as a minimum rotation speed that allows fuel injection into the selected cylinder, which stops in the fuel injection stop range in a stop of the engine 22, immediately before the stop of the engine 22. Execution of this engine stop control enables a cylinder that is expected to stop in the fuel injection stop range on a stop of the engine 22 to receive fuel injection before the stop of the engine 22, upon the setting of the gearshift position SP to the drivable gear position.

When the input rotation speed Ne of the engine 22 decreases to or below the preset fuel injection-start reference rotation speed Nref1 at step S120 and the gearshift position SP identified at step S140 is a non-drivable gear position, that is, the P position or the N position, on the other hand, an immediate restart of the motor vehicle 10 is less likely. The CPU 72 accordingly specifies no requirement of preliminary fuel injection into the cylinder that is expected to stop in the fuel injection stop range on the stop of the engine 22, and keeps the fuel injection prohibited (step S190). This arrangement effectively avoids potential troubles caused by non-combustion of the preliminarily injected fuel under a stop of the engine 22 over a relatively long time, for example, direct discharge of uncombusted fuel from a cylinder receiving the fuel injection and deterioration of lubricating oil in the engine 22 by the uncombusted fuel. The control flow allows the fuel injection (step S150) upon the setting of the gearshift position SP to the drivable gear position, when the rotation speed Ne of the engine 22 decreases to or below the preset fuel injection-start reference rotation speed Nref1. The control flow immediately prohibits the fuel injection again (steps S190), in response to detection of a changeover of the gearshift position SP to the non-drivable gear position (step S170) before the rotation speed Ne of the engine 22 decreases to or below the preset fuel injection-stop reference rotation speed Nref2. The immediate prohibition of the fuel injection again in response to a changeover of the gearshift position SP to the non-drivable gear position desirably reduces the potential troubles caused by non-combustion of the preliminarily injected fuel in the cylinder under a stop of the engine 22 over a relatively long time.

The CPU 72 inputs the crank angle CA from the crank angle sensor 48 at a full stop of the engine 22 (steps S200 and S210) The CPU 72 calculates a crank angle CAa of the cylinder receiving the fuel injection (step S220) and exits from the engine stop control routine of FIG. 3. The calculated crank angle CAa of the cylinder receiving the fuel injection is stored at a predetermined address in the RAM 76.

The system stop control routine is triggered by a changeover of the gearshift position SP to the P position and a subsequent switch-off operation of the ignition switch 80 after the stop of the engine 22. The CPU 72 of the engine ECU 70 first determines whether a cylinder that stops in the fuel injection stop range on a stop of the engine 22 has received fuel injection immediately before the stop of the engine 22 (step S300). When the cylinder has not received the fuel injection immediately before the stop of the engine 22, there are no potential troubles caused by non-combustion of the preliminarily injected fuel under a stop of the engine 22 over a relatively long time. The CPU 72 thus immediately exits from the system stop control routine of FIG. 4 without any further processing.

When the cylinder has received the fuel injection immediately before the stop of the engine 22, on the other hand, the CPU 72 inputs the crank angle CAa of the cylinder receiving the fuel injection (step S310), which was calculated in the engine stop control routine of FIG. 3 on the stop of the engine 22, and identifies whether the cylinder receiving the fuel injection is in the intake stroke (step S320). As mentioned previously, the fuel injection stop range is defined as the range of the crank angle CA between the preset first angle CA1 and the preset second angle CA2 over the intake stroke to the compression stroke in the stop of the engine 22. The cylinder receiving the fuel injection may thus stop in the intake stroke on the stop of the engine 22. The processing of step S320 identifies the presence or the absence of the cylinder that has received the fuel injection and is at a stop in the intake stroke. A cylinder that has received the fuel injection and is at a stop in the compression stroke may be present simultaneously with the cylinder that has received the fuel injection and is at a stop in the intake stroke.

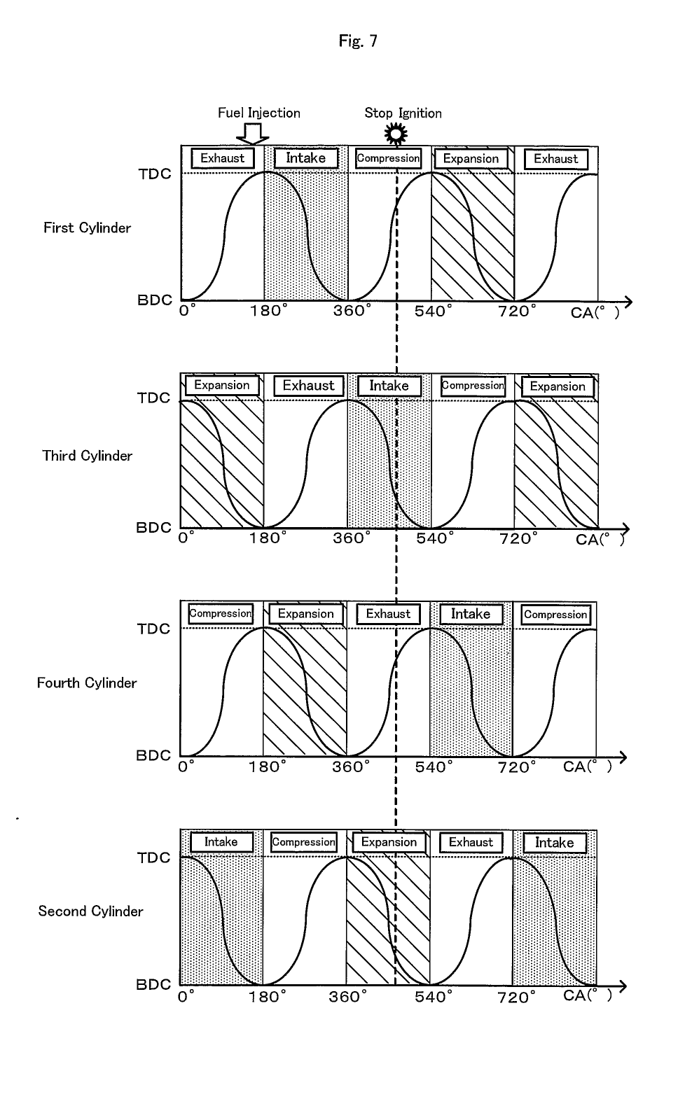

When the cylinder receiving the fuel injection is not in the intake stroke at step S320, the CPU 72 determines whether the input crank angle CAa of the cylinder receiving the fuel injection is included in an ignition range between a preset angle C1 and a preset angle C2 (step S330). When the crank angle CAa of the cylinder receiving the fuel injection is included in the ignition range between the preset angles C1 and C2 at step S330, the engine ECU 70 controls the ignition plug 42 to generate an electric spark and ignite the air-fuel mixture in the cylinder receiving the fuel injection (step S340) and exits from this system stop control routine of FIG. 4. The ignition range between the preset angles C1 and C2 represents a crank angle range that enables combustion of the air-fuel mixture by ignition in the compression stroke. FIG. 6 shows one example of the ignition range. In the illustrated example of FIG. 6, the angle C1 is set to be some angle apart from a bottom dead center BDC in the compression stroke for the purpose of combustion. The angle C2 is set to be close to a top dead center TDC in the compression stroke. Ignition of the air-fuel mixture in the compression stroke may cause the engine 22 to slightly rotate in the reverse direction. FIG. 7 shows fuel injection into the first cylinder 22a that is expected to stop in the fuel injection stop range, as well as ignition in the first cylinder 22a in the ignition range in response to a changeover of the gearshift position SP to the P position and a subsequent switch-off operation of the ignition switch 80 after the stop of the engine 22. In the illustrated example of FIG. 7, the first cylinder 22a stops in the ignition range in the compression stroke and accordingly has immediate ignition. Such ignition desirably avoids the potential troubles caused by non-combustion of the preliminarily injected fuel under a stop of the engine 22 over a relatively long time.

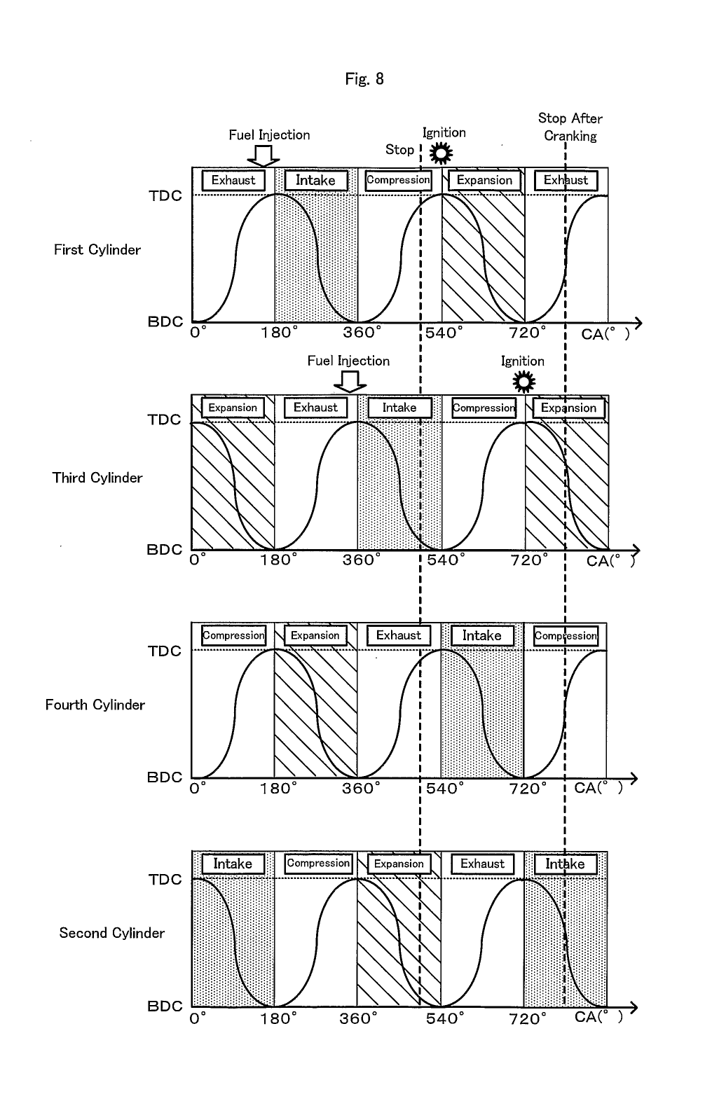

When the cylinder receiving the fuel injection is in the intake stroke at step S320 or when the cylinder receiving the fuel injection is not in the intake stroke at step S320 but has the crank angle CAa out of the ignition range between the preset angles C1 and C2 at step S330, the cylinder receiving the fuel injection is under a non-ignitable condition with an electric spark of the ignition plug 42. In such cases, the engine ECU 70 cranks the engine 22 and ignites the air-fuel mixture in the cylinder receiving the fuel injection when the crank angle CAa of the cylinder enters a standard ignition timing (step S350). The engine ECU 70 then exits from the system stop control routine of FIG. 4. FIG. 8 shows fuel injection into the first cylinder 22a and the third cylinder 22c that are expected to stop in the fuel injection stop range, as well as ignition with engine cranking in the first cylinder 22a and the third cylinder 22c in response to a changeover of the gearshift position SP to the P position and a subsequent switch-off operation of the ignition switch 80 after the stop of the engine 22. In the illustrated example of FIG. 8, the air-fuel mixture is ignited sequentially in the first cylinder 22a and the third cylinder 22c, which sequentially enter the standard ignition timing by cranking the engine 22. After the sequential ignition in the first cylinder 22a and the third cylinder 22c, the engine 22 fully stops. When the cylinder receiving the fuel injection is under a non-ignitable condition, ignition with engine cranking is performed to desirably avoid the potential troubles caused by non-combustion of the preliminarily injected fuel under a stop of the engine 22 over a relatively long time.

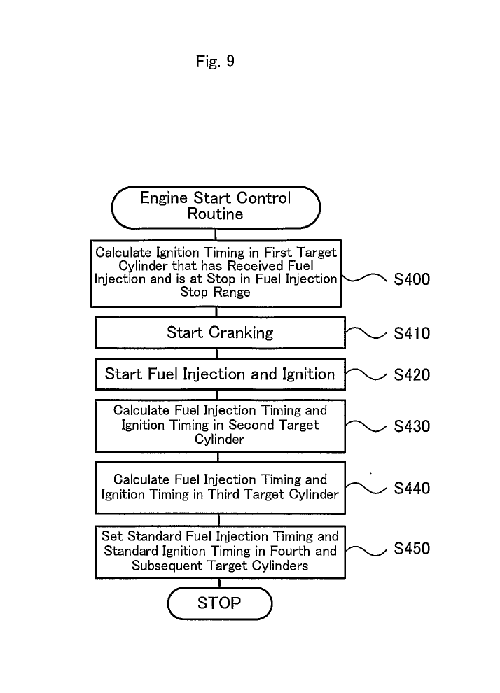

FIG. 9 is a flowchart showing an engine start control routine executed by the engine ECU 70 upon satisfaction of preset automatic engine start conditions without a switch-off operation of the ignition switch 80. In the engine start control routine of FIG. 9, the CPU 72 of the engine ECU 70 first calculates an ignition timing in a first target cylinder that has received fuel injection and is at a stop in the fuel injection stop range, based on the crank angle CA on the stop of the engine 22 (step S400). When a cylinder, which was expected to stop in the fuel injection stop range and received the fuel injection, is actually at a stop in the fuel injection stop range, the engine start control routine calculates the ignition timing in the cylinder as the first target cylinder (the first cylinder 22a in the illustrated example of FIG. 2). When a changeover of the gearshift position SP to the P position to the N position prohibits the preliminary fuel injection into the cylinder that was expected to stop in the fuel injection stop range on the stop of the engine 22, the engine start control routine does not calculate the ignition timing in the cylinder. The CPU 72 then initiates cranking (step S410), activates the fuel injection valve 32 and the ignition plug 42 to start fuel injection and ignition (step S420), and calculates a fuel injection timing and an ignition timing in a second target cylinder, which has an ignition timing after the first target cylinder stopping in the fuel injection stop range (step S430). When the first cylinder 22a is at a stop in the fuel injection stop range after receiving the fuel injection as in the state of FIG. 2 or when the first cylinder 22a is at a stop without fuel injection, the third cylinder 22c as the second target cylinder having the ignition timing after the first cylinder 22a is at a stop in the intake stroke. For combustion of the air-fuel mixture at a first ignition timing in the third cylinder 22c, it is required to inject the fuel in the course of the intake stroke and to introduce the injected fuel into the combustion chamber 40. The calculation at step S430 thus sets the timing of fuel injection before the end of the intake stroke in the third cylinder 22c. The CPU 72 subsequently calculates a fuel injection timing and an ignition timing in a third target cylinder having a third ignition timing (step S440), and sets a standard fuel injection timing and a standard ignition timing in fourth and subsequent target cylinders having fourth and subsequent ignition timings (step S450). The engine start control routine is terminated after the processing of step S450. The engine start control calculates the fuel injection timing and the ignition timing and performs fuel injection and ignition respectively at the calculated fuel injection timing and at the calculated ignition timing. Such control enables combustion of the air-fuel mixture in the first target cylinder that has received fuel injection and is at a stop in the fuel injection stop range, as well as combustion in the subsequent cylinders having subsequent ignition timings, at a restart of the engine 22. The combustion energy is effectively usable to raise the rotation speed Ne of the engine 22. This ensures a quick start of the engine 22.

As described above, upon the setting of the gearshift position SP to the non-drivable gear position, the driving apparatus 20 of the embodiment prohibits preliminary fuel injection into the cylinder that stops in the fuel injection stop range on the stop of the engine 22, even when the rotation speed Ne of the engine 22 decreases to or below the preset fuel injection-start reference rotation speed Nref1. This arrangement effectively avoids potential troubles caused by non-combustion of the preliminarily injected fuel under a stop of the engine 22 over a relatively long time, for example, direct discharge of uncombusted fuel from a cylinder receiving the fuel injection and deterioration of lubricating oil in the engine 22 by the uncombusted fuel. After the preliminary fuel injection into the cylinder that stops in the fuel injection stop range on the stop of the engine 22, in response to a changeover of the gearshift position SP to the P position and a subsequent switch-off operation of the ignition switch 80, the driving apparatus 20 ignites the air-fuel mixture in the cylinder with or without engine cranking according to the stop position of the cylinder. Such ignition effectively avoids potential troubles caused by non-combustion of the preliminarily injected fuel in the cylinder under a stop of the engine 22 over a relatively long time. Upon the setting of the gearshift position SP to the drivable gear position, the driving apparatus 20 allows preliminary fuel injection into the cylinder that stops in the fuel injection stop range on the stop of the engine 22. This ensures a quick restart of the engine 22.

In an auto restart of the engine 22, the driving apparatus of the invention calculates the ignition timing of the first target cylinder at a stop in the fuel injection stop range and the fuel injection timing and the ignition timing of the second and the third target cylinders having the second and the third ignition timings, and performs fuel injection and ignition at the calculated respective fuel injection timings and ignition timings. Such control ensures ignition and combustion of the air-fuel mixture in the first target cylinder that has received fuel injection and has stopped in the fuel injection stop range, as well as ignition and combustion in the subsequent target cylinders having the subsequent ignition timings, in the restart of the engine 22. The combustion energy is thus effectively usable to raise the rotation speed Ne of the engine 22. This ensures a quick start of the engine 22.

Upon the setting of the gearshift position SP to the non-drivable gear position, the driving apparatus 20 of the embodiment prohibits preliminary fuel injection into the cylinder that stops in the fuel injection stop range on the stop of the engine 22, even when the rotation speed Ne of the engine 22 decreases to or below the preset fuel injection-start reference rotation speed Nref1. One possible modification may allow preliminary fuel injection into the cylinder that stops in the fuel injection stop range on the stop of the engine 22, regardless of the setting of the gearshift position SP.

The driving apparatus 20 of the embodiment allows the fuel injection upon the setting of the gearshift position SP to the drivable gear position, when the rotation speed Ne of the engine 22 decreases to or below the preset fuel injection-start reference rotation speed Nref1. The driving apparatus 20 of the embodiment immediately prohibits the fuel injection again, in response to detection of a changeover of the gearshift position SP to the non-drivable gear position before the rotation speed Ne of the engine 22 decreases to or below the preset fuel injection-stop reference rotation speed Nref2. One possible modification may keep the preliminary fuel injection into the cylinder that stops in the fuel injection stop range on the stop of the engine 22, regardless of a change in setting of the gearshift position SP.

After the preliminary fuel injection into the cylinder that stops in the fuel injection stop range on the stop of the engine 22, in response to a changeover of the gearshift position SP to the P position and a subsequent switch-off operation of the ignition switch 80, the driving apparatus 20 of the embodiment ignites the air-fuel mixture in the cylinder with or without engine cranking according to the stop position of the cylinder. One modified control procedure may, in response to a switch-off operation of the ignition switch 80, ignite the air-fuel mixture in the cylinder with or without engine cranking according to the stop position of the cylinder, irrespective of the setting of the gearshift position SP. Another modified control procedure may, in response to a changeover of the gearshift position SP to the P position, ignite the air-fuel mixture in the cylinder with or without engine cranking according to the stop position of the cylinder, irrespective of an on-off operation of the ignition switch 80.

After the preliminary fuel injection into the cylinder that stops in the fuel injection stop range on the stop of the engine 22, in response to a changeover of the gearshift position SP to the P position and a subsequent switch-off operation of the ignition switch 80, the driving apparatus 20 of the embodiment ignites the air-fuel mixture in the cylinder with or without engine cranking according to the stop position of the cylinder. In one possible modification, the ignition may unconditionally be accompanied with engine cranking, regardless of the stop position of the cylinder. In another possible modification, the ignition may unconditionally be performed without engine cranking to ignite the air-fuel mixture only in the cylinder under an ignitable condition.

In the case of ignition with engine cranking, the driving apparatus 20 of the embodiment ignites the air-fuel mixture in the cylinder receiving the fuel injection at the standard ignition timing. The timing of ignition is, however, not restricted to the standard ignition timing but may be set arbitrarily to ignite the air-fuel mixture in the cylinder receiving the fuel injection.

In the driving apparatus 20 of the embodiment, the fuel injection is allowed while the rotation speed Ne of the engine 22 decreases from the preset fuel injection-start reference rotation speed Nref1 to or below the preset fuel injection-stop reference rotation speed Nref2. The fuel is accordingly injected before a stop of the engine 22 into the cylinder that stops in the fuel injection stop range between the preset first angle CA1 and the preset second angle CA2 on the stop of the engine 22. One modified control procedure may predict the stop position of the engine 22 according to the rotations speed Ne of the engine 22 and identify the cylinder, which is estimated to stop in the fuel injection stop range, based on the predicted stop position of the engine 22. The fuel is then injected into the identified cylinder before the stop of the engine 22.

In the driving apparatus 20 of the embodiment, the throttle valve 28 is regulated to the specific opening that enables the engine 22 to be driven at an idle rotation speed in the process of stopping the engine upon satisfaction of the preset automatic engine stop conditions. The opening of the throttle valve 28 may be restricted to decrease the intake air flow in the process of fuel injection into a cylinder that stops in the fuel injection stop range in a stop of the engine 22. Such restriction decreases the combustion energy at the time of ignition in the compression stroke of the cylinder in response to a subsequent switch-off operation of the ignition switch 80. The decreasing combustion energy desirably reduces potential vibrations due to the explosive combustion and prevents reverse rotation of the engine 22.

In the internal combustion engine system 20 of the embodiment, the fuel injection stop range is set as an area over the intake stroke to the compression stroke. The fuel injection stop range may be limited to an area within the compression stroke.

The embodiment discussed above is to be considered in all aspects as illustrative and not restrictive. There may be many modifications, changes, and alterations without departing from the scope or spirit of the main characteristics of the present invention. All changes within the meaning and range of equivalency of the claims are intended to be embraced therein.

### INDUSTRIAL APPLICABILITY

The technique of the invention is preferably adopted in driving apparatus manufacturing industries.

1. A driving apparatus including an internal combustion engine that has multiple cylinders and is capable of outputting power to a drive shaft, said driving apparatus comprising:
an engine stop-restart control module that, in response to reception of a stop instruction of the internal combustion engine, controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine,
in response to reception of a start instruction of the internal combustion engine, said engine stop-restart control module controlling the internal combustion engine to start with ignition of an air-fuel mixture at a first ignition timing in the specific cylinder that stops in the predetermined range;
a state changeover structure that, in response to an operator's manipulation, changes over the state of said driving apparatus between a drivable state that enables output of the power of the internal combustion engine to the drive shaft and an undrivable state that prohibits output of the power of the internal combustion engine to the drive shaft,
a state detection unit that detects the state of said driving apparatus changed over by the state changeover structure as a state of said driving apparatus; and
an avoidance control module that executes potential trouble avoidance control based on the detected state of said driving apparatus, so as to avoid a potential trouble arising in the internal combustion engine due to non-combustion of preliminarily injected fuel, when the state detection unit detects a changeover of the state of said driving apparatus to the undrivable state by the state changeover structure, said avoidance control module executes the potential trouble avoidance control, which controls said engine stop-restart control module to prohibit the preliminary fuel injection before the stop of the internal combustion engine.

2. (canceled)

3. A driving apparatus in accordance with claim 1, said driving apparatus further comprising:
an activation-inactivation instruction unit that gives an activation command and an inactivation command to activate and inactivate said driving apparatus, in response to the operator's manipulation,
wherein the state detection unit detects the inactivation command of the said driving apparatus given by the activation-inactivation instruction unit, and
in response to detection of the inactivation command of said driving apparatus by the state detection unit after the preliminary fuel injection by said engine stop-restart control module, said avoidance control module executes the potential trouble avoidance control, which controls said internal combustion engine to ignite the air-fuel mixture in the specific cylinder receiving the preliminary fuel injection before the stop of the internal combustion engine.

4. A driving apparatus in accordance with claim 3, wherein upon condition that the specific cylinder receiving the preliminary fuel injection by said engine stop-restart control module before the stop of the internal combustion engine is at a stop in a preset range in the compression stroke, said avoidance control module executes the potential trouble avoidance control, which controls said internal combustion engine to ignite the air-fuel mixture in the specific cylinder, in response to detection of the inactivation command of said driving apparatus by the state detection unit.

5. A driving apparatus in accordance with claim 4, wherein upon condition that the specific cylinder receiving the preliminary fuel injection by said engine stop-restart control module before the stop of the internal combustion engine is not at a stop in the preset range in the compression stroke, said avoidance control module executes the potential trouble avoidance control, which controls said internal combustion engine to be cranked with the ignition of the air-fuel mixture in the specific cylinder.

6. A driving apparatus in accordance with claim 3, wherein said avoidance control module executes the potential trouble avoidance control, which controls said internal combustion engine to be cranked with the ignition of the air-fuel mixture in the specific cylinder receiving the preliminary fuel injection, after the stop of the internal combustion engine by said engine stop-restart control module.

7. (canceled)

8. (canceled)

9. (canceled)

10. (canceled)

11. A driving apparatus in accordance with claim 1, wherein said avoidance control module executes the potential trouble avoidance control, which controls said internal combustion engine to decrease an amount of intake air flow into the internal combustion engine at a time of the preliminary fuel injection into the specific cylinder that stops in the predetermined range on the stop of the internal combustion engine.

12. A motor vehicle, comprising:
an internal combustion engine that has multiple cylinders and is capable of outputting power to an axle of said motor vehicle;
an engine stop-restart control module that, in response to reception of a stop instruction of the internal combustion engine, controls the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine,
in response to reception of a start instruction of the internal combustion engine, said engine stop-restart control module controlling the internal combustion engine to start with ignition of an air-fuel mixture at a first ignition timing in the specific cylinder that stops in the predetermined range;
a state changeover structure that, in response to an operator's manipulation, changes over the state of said motor vehicle between a drivable state that enables output of the power of the internal combustion engine to the axle and an undrivable state that prohibits output of the power of the internal combustion engine to the axle,
a state detection unit that detects the state of said motor vehicle changed over by the state changeover structure as a state of said motor vehicle; and
an avoidance control module that executes potential trouble avoidance control based on the detected state of said motor vehicle, so as to avoid a potential trouble arising in the internal combustion engine due to non-combustion of preliminarily injected fuel, when the state detection unit detects a changeover of the state of said motor vehicle to the undrivable state by the state changeover structure, said avoidance control module executes the potential trouble avoidance control, which controls said engine stop-restart control module to prohibit the preliminary fuel injection before the stop of the internal combustion engine.

13. (canceled)

14. A motor vehicle in accordance with claim 12, said motor vehicle further comprising:
a start-stop instruction unit that gives a start command and a stop command to start and stop said motor vehicle, in response to an operator's manipulation,
wherein the state detection unit detects the stop command of said motor vehicle given by the start-stop instruction unit, and
in response to detection of the stop command of said motor vehicle by the state detection unit, said avoidance control module executes the potential trouble avoidance control, which controls said internal combustion engine to ignite the air-fuel mixture in the specific cylinder receiving the preliminary fuel injection before the stop of the internal combustion engine.

15. A motor vehicle in accordance with claim 12, wherein said avoidance control module executes the potential trouble avoidance control, which controls said internal combustion engine to decrease an amount of intake air flow into the internal combustion engine at a time of the preliminary fuel injection into the specific cylinder that stops in the predetermined range on the stop of the internal combustion engine.

16. A control method of a driving apparatus, said driving apparatus including: an internal combustion engine that has multiple cylinders and is capable of outputting power to a drive shaft; and a state changeover structure that, in response to an operator's manipulation, changes over a state of said driving apparatus between a drivable state that enables output of the power of the internal combustion engine to the drive shaft and an undrivable state that prohibits output of the power of the internal combustion engine to the drive shaft,
in response to reception of a stop instruction of the internal combustion engine, said driving apparatus control method controlling the internal combustion engine to allow preliminary fuel injection before a stop of the internal combustion engine into a specific cylinder, which stops in a predetermined range including part of a compression stroke on the stop of the internal combustion engine, among the multiple cylinders of the internal combustion engine, in the event of a changeover of the state of said driving apparatus to the undrivable state by the state changeover structure, said driving apparatus control method controlling the internal combustion engine to prohibit the preliminary fuel injection before the stop of the internal combustion engine,
in response to reception of a start instruction of the internal combustion engine, said driving apparatus control method controlling the internal combustion engine to start with ignition of an air-fuel mixture at a first ignition timing in the specific cylinder that stops in the predetermined range.

17. (canceled)
